(19) United States
(12) Patent Application Publication
(10) Pub. No.: US 2010/0042494 A1
(43) Pub. Date: Feb. 18, 2010

(54) Systems and Methods for Visualization of Real-Time Advertisement Inventory

(76) Inventor: Kevin Pomplun, Palo Alto, CA (US)

Correspondence Address: CARR & FERRELL LLP, 2200 GENG ROAD, PALO ALTO, CA, 94303, US

(21) Appl. No.: 12/490,283

(22) Filed: Jun. 23, 2009

Related U.S. Application Data
(63) Continuation-in-part of application No. 12/319,314, filed on Jan. 5, 2009.
Application No. 12/319,314 is a continuation-in-part of application No. 12/324,596, filed on Nov. 26, 2008.
Application No. 12/324,596 is a continuation of application No. 11/843,813, filed on Aug. 23, 2007, now Pat. No. 7,464,003.
Application No. 11/843,813 is a continuation-in-part of application No. 12/324,596, filed on Nov. 26, 2008.
Application No. 12/324,596 is a continuation of application No. 11/843,813, filed on Aug. 23, 2007, now Pat. No. 7,464,003.
(60) Provisional application No. 60/823,478, filed on Aug. 24, 2006.
(60) Provisional application No. 60/823,478, filed on Aug. 24, 2006.

(51) Int. Cl. G06Q 30/00; G06F 3/048; G06Q 50/00

(52) U.S. Cl. 705/14.45; 705/14.54; 705/14.73; 715/848; 715/764

(57) ABSTRACT

Systems and methods for visualization of real-time advertisement inventory are provided. An exemplary method for real-time display on a graphical user interface of advertisements delivered over a network is given. An identifier is displayed corresponding to a web site displaying an advertisement. Quantitative data is displayed with respect to the advertisement displayed on the web site. A type of content associated with the advertisement on the web side is displayed. A second web site for routing the advertisement is displayed. A frequency in which the advertisement is displayed on the web site is displayed.

### CROSS-REFERENCE TO RELATED APPLICATIONS

This nonprovisional application claims the benefit and priority of U.S. patent application Ser. No. 12/319,314 filed on Jan. 5, 2009, titled “Systems and Methods for Content Delivery,” which is a continuation-in-part application claiming the benefit and priority of U.S. patent application Ser. No. 12/324,596 filed on Nov. 26, 2008, titled “System and Method for Change Detection of Information or Type of Data,” which is a continuation application claiming the benefit and priority of U.S. patent application Ser. No. 11/843,813 filed on Aug. 23, 2007, titled “System and Method for Change Detection of Information or Type of Data,” now U.S. Pat. No. 7,464,003 as issued on Dec. 9, 2008, which claims the benefit and priority of U.S. Provisional Patent Application Ser. No. 60/823,478 filed on Aug. 24, 2006, titled “Dynamic Information System,” all of which are hereby incorporated by reference. This nonprovisional application also claims the benefit and priority of U.S. patent application Ser. No. 12/324,596 filed on Nov. 26, 2008, titled “System and Method for Change Detection of Information or Type of Data,” which is a continuation application claiming the benefit and priority of U.S. patent application Ser. No. 11/843,813 filed on Aug. 23, 2007, titled “System and Method for Change Detection of Information or Type of Data,” now U.S. Pat. No. 7,464,003 as issued on Dec. 9, 2008, which claims the benefit and priority of U.S. Provisional Patent Application Ser. No. 60/823,478 filed on Aug. 24, 2006, titled “Dynamic Information System,” all of which are hereby incorporated by reference.

### FIELD OF INVENTION

This invention relates generally to systems and methods for visualization, and more particularly, for visualization of real-time advertisement inventory.

### SUMMARY OF THE INVENTION

An object of the present invention is to provide systems and methods that provide a visual inventory of possible advertisement sites.

Another object of the present invention is to provide systems and methods that deliver advertisements over a network in real time.

Yet another object of the present invention is to provide systems and methods that provide information relating to one or more advertisements in a multi-dimensional object or in a multiple-sided display object.

These and other objects of the present invention are achieved in a method for real-time display on a graphical user interface of advertisements delivered over a network. In one embodiment of the present invention, an identifier is displayed corresponding to a web site displaying an advertisement. Quantitative data is displayed with respect to the advertisement displayed on the web site. A type of content associated with the advertisement on the web side is displayed. A second web site for routing the advertisement is displayed. A frequency in which the advertisement is displayed on the web site is displayed.

In another embodiment of the present invention, a method is provided for real-time delivery of advertisements over a network. A keyword representing a type of content for a web site is received. An identifier representing the web site associated with the keyword is received. The advertisement is transmitted for display on the web site.

### BRIEF DESCRIPTION OF THE DRAWINGS

FIG. 1 is a flow chart showing an exemplary method for displaying advertisements.

FIG. 2 is a diagram of an exemplary architecture of a system for providing advertisements.

FIG. 3 illustrates an exemplary screenshot of a display on a device interacting with some of the various embodiments disclosed herein.

FIG. 4 is a flow chart showing an exemplary method for delivering advertisements.

FIGS. 5A, 5B, 5C, 5D, and 5E illustrate exemplary screenshots of a display showing a rotating multiple-sided display object in accordance with some of the various embodiments disclosed herein.

### DETAILED DESCRIPTION OF THE INVENTION

Advertisements can be powerful tools of persuasion if they reach the target audiences. In order to reach target audiences, oftentimes advertisements must be strategically placed such that the target audiences will be exposed to the advertisements. Thus, it may be important information or data for a user (such as an advertiser) to know where the user's advertisement is being placed. A user may wish to have this information via real-time delivery. A user may wish to know where a competitor's advertisements are being placed.

Also, identifying potential places or sites for advertisement placement may be important for a user, such that the user may be assured that the advertisement reaches the intended target audiences. In other words, a user may wish to identify advertisement purchasing opportunities. In some instances, a user may wish to select one or more potential sites that were previously identified, such that the potential sites now display the advertisement. Further, a user may be interested in determining how frequently an advertisement is being displayed on a web site or a web page. The user may wish to see a visual or graphical display of information regarding advertisements. Exemplary displays of information may be in the form of a graphical user interface on a web page, a rotating multiple-sided display object, or a multi-dimensional object.

To meet these needs and other requirements of users, systems and methods for providing a real-time delivery of advertisements are provided herein. Also, systems and methods for providing a real-time display of advertisements delivered over a network are given. These various exemplary systems and methods may provide a user with vital information about an advertisement. An exemplary, non-exhaustive list of such information includes: information about where the advertisement is being placed, information of potential sites where the advertisement may be placed, information about the frequency in which an advertisement is displayed on a web site, quantitative data regarding the advertisement, information about a type of content associated with the advertisement displayed, information about where a third-party's advertisement may be placed on one or more web sites, routing information about an advertisement, and any combination thereof. A network (such as the Internet) may be scanned for advertisements and information relating to advertisements.

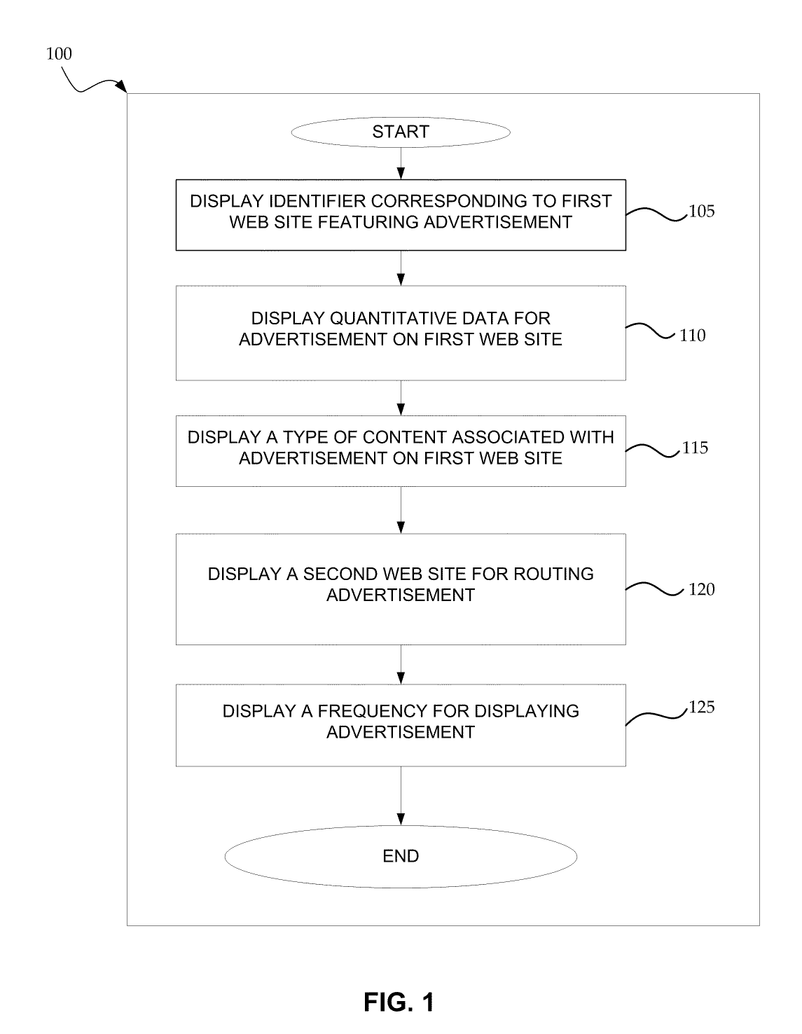

FIG. 1 is a flow chart showing an exemplary method 100 for displaying advertisements. FIG. 1 and all the figures included in this description are exemplary only, and one skilled in the art will understand that the scope of this disclosure is not limited to what is provided in the figures only. According to various exemplary embodiments, the method 100 is a computer-implemented method for real-time display on a graphical user interface of advertisements delivered over a network. The network may be the Internet, a mobile network, a local area network, or any combination thereof. The network may be a local, proprietary network (e.g., intranet) and/or may be a part of a larger wide-area network. For example, the network may be a local area network (LAN), which may also be communicatively coupled to a wide area network (WAN) such as the Internet. The network allows for communication between the various components of one or more systems described later herein.

The advertisements may be displayed on a display. The display is on any type of medium. The display may be a display of a device. The device itself may be a computing device, a laptop computer, a desktop computer, a user digital device, a mobile communications device, a server, a handheld computer, a smartphone, a personal digital assistant, a mobile communications device, music player, game console, GPS device, networked sensor, card key reader, credit card reader, other digital computing device, and any combination thereof. The device may have a processor and storage memory. The device may be configured to communicate via a network. Further discussion on exemplary architectural frameworks is provided later herein.

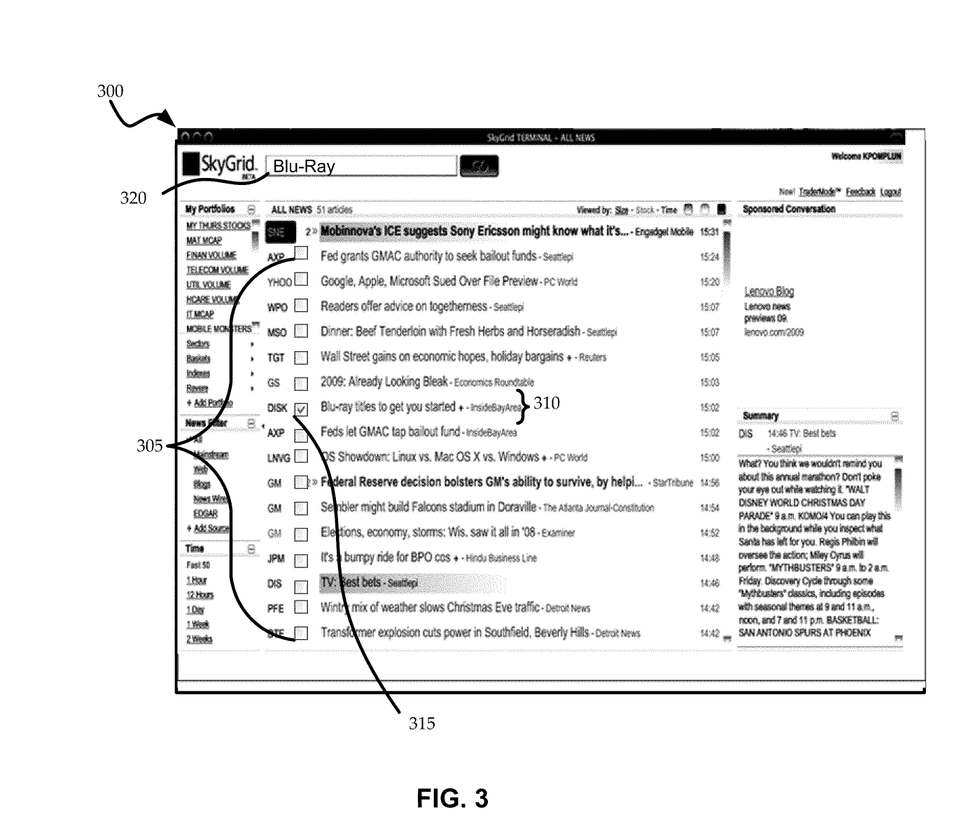

In some exemplary embodiments, the method 100 for displaying advertisements is in response to a query made via a device. The query may be one or more key words typed or otherwise entered into a query box located on a web page. A user of the device may browse to the web page having the query box, and may then type or otherwise enter a query into the query box. The user may then click on the “enter” key or otherwise enter the information, which then begins the processing of one or more of the methods described herein. As a result of the processing, the display of advertisements is triggered, using the method 100. An exemplary embodiment of a web page having a query box 320 is shown in FIG. 3, which will be discussed in greater detail later herein.

Still referring to FIG. 1, at step 105, an identifier corresponding to a first web site displaying or featuring an advertisement is displayed. The identifier displayed may include a name of a first web site, a link to the first web site, an address of the first web site, and any combination thereof. In other words, the identifier corresponds to a first web site that currently displays, features, includes or otherwise provides the advertisement. An example of an identifier is shown in FIG. 3, which is an exemplary screenshot 300 of a display on a user digital device interacting with some of the various embodiments disclosed herein. An item (or story title) next to a checked box 315 of an entry 310 is entitled “Blu-ray titles to get you started,” and it includes an identifier of “InsideBayArea.” The checked box 315 indicates that the user has selected for the advertisement to be included on the web site identified in the item. In other words, the advertisement is currently “turned on” and appears on the web site. The web site identified by the identifier of the item is “InsideBayArea.” If the identifier were a link to the web site, then the URL link to “InsideBayArea” may be provided. If the identifier were the IP address of the web site, then the IP address of the web site “InsideBayArea” would be shown.

Referring back to FIG. 1, at step 110, quantitative data with respect to the advertisement displayed on the first web site is displayed. An exemplary, non-exhaustive list of he quantitative data includes a number of impressions for the advertisement on the first web site, a number of impressions for the advertisement on the first web site for a particular day, a click-through rate for an advertisement on a first web site, a time or a position of the advertisement on the first web site, an indication of a change in the time or the position of the advertisement on the first web site, an indication of a change to the first web site, and any combination thereof. One skilled in the art will appreciate that the quantitative data may be provided in any format. The quantitative data may be provided in a numerical format. For instance, if the quantitative data is click-through rate for an advertisement on the first web site, then any numerical data may be provided. Thus, a term of “800” as the quantitative data may indicate that 800 clicks were performed on the advertisement on the first web site.

The quantitative data may be represented in a data entry, such as a data entry in a grid or a table. Another exemplary embodiment is a quantitative data that is manifested as a color associated with the advertisement. If the advertisement is displayed, it may be shadowed, highlighted or otherwise associated with a particular color depending on the quantitative data with respect to the advertisement. If the number of impressions for an advertisement exceeds a certain threshold, then the advertisement may be highlighted in a first color (such as green). If the number of impressions for an advertisement does not exceed a certain threshold, then the advertisement may be highlighted in a second color (such as red).

Referring back to the entry 310 in FIG. 3, a further example of exemplary quantitative data is provided in the form of a time stamp shown as “15:02.” The time “15:02” may be the time that the advertisement was placed on the web site of “InsideBayArea.” Alternatively, the time “15:02” may be an indication of a change in time of the advertisement of the web site. Alternatively, the time “15:02” may indicate that the advertisement has been on the web site for a total time of 15:02, which could be interpreted in a variety of ways depending on the type of time designations used. For example, “15:02” may mean 15 minutes and 2 seconds or 15 hours and two minutes.

At step 115, a type of content associated with the advertisement on the first web site is displayed. The type of content displayed may include any type of information. An exemplary type of content includes a title of a story. In the entry 315 found in FIG. 3, the type of content is the title of the story, which is “Blu-ray titles to get you started.” The title of the story may include an identifier of whether the advertisement is associated with the story. The identifier showing whether the advertisement is associated with the story may be shown in any number of ways, such as a link, a word, a symbol (e.g., an asterisk), a visual indicator, and the like.

As previously discussed, one or more keywords in the form of a query may be received from a device. In response to the receipt of the keyword, a matching of the received keyword to a web site on the network for displaying the advertisement may be accomplished. For instance, if a query of “Blackberry smartphones” is entered, then the received keywords will be matched to one or more web sites on the network that display an advertisement relating to Blackberry smartphones. The query search result may provide advertisements relating to such products as Blackberry Bold smartphones, Blackberry Curve smartphones, and Blackberry smartphones in general.

A matching of the received keyword corresponding to a sector to a web site on the network for displaying the advertisement may be done. If the user wishes to search the Information Technology sector, the user can select the Information Technology sector by utilizing one or more of the exemplary methods described in U.S. patent application Ser. No. 12/319,314 filed on Jan. 5, 2009, titled “Systems and Methods for Content Delivery,” which is incorporated by reference herein in its entirety. Once the Information Technology sector is selected for searching, the user can view which pages have ads from any number of companies or businesses that are grouped in the Information Technology sector. A user could determine which web pages have advertisements from both Google and Sony, and may then decide to place an Intuit ad on those web pages having both Google and Sony advertisements. Further user options may also be available for a user to have the user's advertisements displayed only, a third party's advertisements displayed only, identified potential advertisement placements (in the form of web sites) displayed only, and any combination thereof. One skilled in the art will recognize that such user options can be provided in any type of user interface, such as designated keys, drop-down menus, radio buttons, and the like.

A matching of the received keyword to a web site on the network displaying an advertisement of a third-party (e.g., a competitor) may be done. If an advertiser wishes to place Blackberry advertisements on web sites that already display advertisements regarding iPhones, then the user may type in a query of “iPhones” in the query box (such as the query box 320 in FIG. 3) and then when presented with identified web sites that already display iPhone advertisements, the user can select those web sites to now display a Blackberry advertisement as well by clicking on the check boxes associated with those identified web sites having iPhone advertisements. It will be appreciated by one skilled in the art that any number of the embodiments regarding matching of received keyword(s) can be combined or otherwise used in conjunction with each other. For example, the matching of the received keywords corresponding to a sector and the matching of the received keywords to a web site on the network displaying an advertisement of a third-party may be combined or may be done in a sequence such that the technology can filter which web sites have the sought-after advertisement placements.

The advertisements may be displayed on the display of the device in real-time. In some exemplary embodiments, the real-time delivery of advertisements may comprise advertisements matched or selected to the query due to the real-time delivery having a predefined velocity value or a predefined component of velocity value, as described in U.S. patent application Ser. No. 12/319,314 filed on Jan. 5, 2009, titled “Systems and Methods for Content Delivery.” For example, the matched or selected real-time delivery of advertisements may have been generated, edited, or modified at the same time, at nearly the same time, or shortly after the time the query was received. The matched or selected real-time delivery of advertisements may comprise text, audio, video, html links, or any combination thereof of advertisements matched or selected due at least in part to the timely relevance of the content of the advertisement and/or the content of the first web page.

At step 120, a second web site for routing the advertisement is displayed. The second web site may be in the form of a dashboard of information regarding advertisements displayed to a device. An exemplary screenshot 300 of a second web site is provided in FIG. 3. As will be discussed in greater detail later herein, the exemplary screenshot 300 of the second web site provides checkboxes adjacent to items, where the items provide information regarding advertisements. According to various exemplary embodiments, the second web site may include the routed advertisement, as well as any of the information displayed in any of the other steps provided in the method 100.

At step 125, a frequency in which the advertisement is displayed on the first web site is displayed. According to some exemplary embodiments, the frequency is each time the advertisement appears on one visible side of a multiple-sided display object having three dimensions. The multiple-sided display object may be rotating. More than one visible side of the rotating multiple-sided display object having three dimensions may appear at a particular point in time. Each visible side of the rotating multiple-sided display can have at least one advertisement. The rotating multiple-sided display object may be a prism, a cube, a polyhedron, an airplane, or any combination thereof. In the case of where the rotating multiple-sided display object is a polyhedron, the polyhedron may be an octahedron, a dodecahedron, an icosidodecahedron, an elongated pentagonal cupola, a pyramid and any combination thereof. The rotating multiple-sided display object having three dimensions may rotate horizontally, vertically, or both horizontally and vertically. The rotation may be a partial rotation or an entire rotation. It will be understood by one skilled in the art that the rotating multiple-sided display object may appear on any portion of a web site.

An exemplary embodiment is a rotating cube having three sides, each side showing an advertisement from a web site. It will be appreciated by one skilled in the art that for a rotating multiple-sided display object, one or more sides of the multiple-side display object may display the same advertisement. In some embodiments, for any rotating multiple-sided display object, the multiple-sided display object may display a plurality of advertisements, where at least two of the sides of the multiple-sided display object display different advertisements. An exemplary embodiment is where a first side of the three-sided display object may display a first advertisement, a second side of the three-sided display object may display a second advertisement, and a third side of the three-sided display object may display a third advertisement.

Still referring to step 125, according to further exemplary embodiments, the frequency in which the advertisement is displayed on the first web site is each time the advertisement appears on at least one side of a multi-dimensional object. In some embodiments, the multi-dimensional object appears on a second web site, to which the advertisement has been routed. With a rotating multi-dimensional object, one or more sides of the multi-dimensional object may display the same advertisement. The multi-dimensional object may include the advertisement and at least one other advertisement. In some embodiments, for any multi-dimensional object, the multiple-sided display object may display a plurality of advertisements, where at least two of the sides of the multi-dimensional object display different advertisements. In one exemplary embodiment, if the multi-dimensional object has three dimensions and four sides, then a first side of the multi-dimensional display object may display a first advertisement, a second side of the multi-dimensional display object may display a second advertisement, a third side of the multi-dimensional display object may display a third advertisement, and a fourth side of the multi-dimensional display object may display a fourth advertisement.

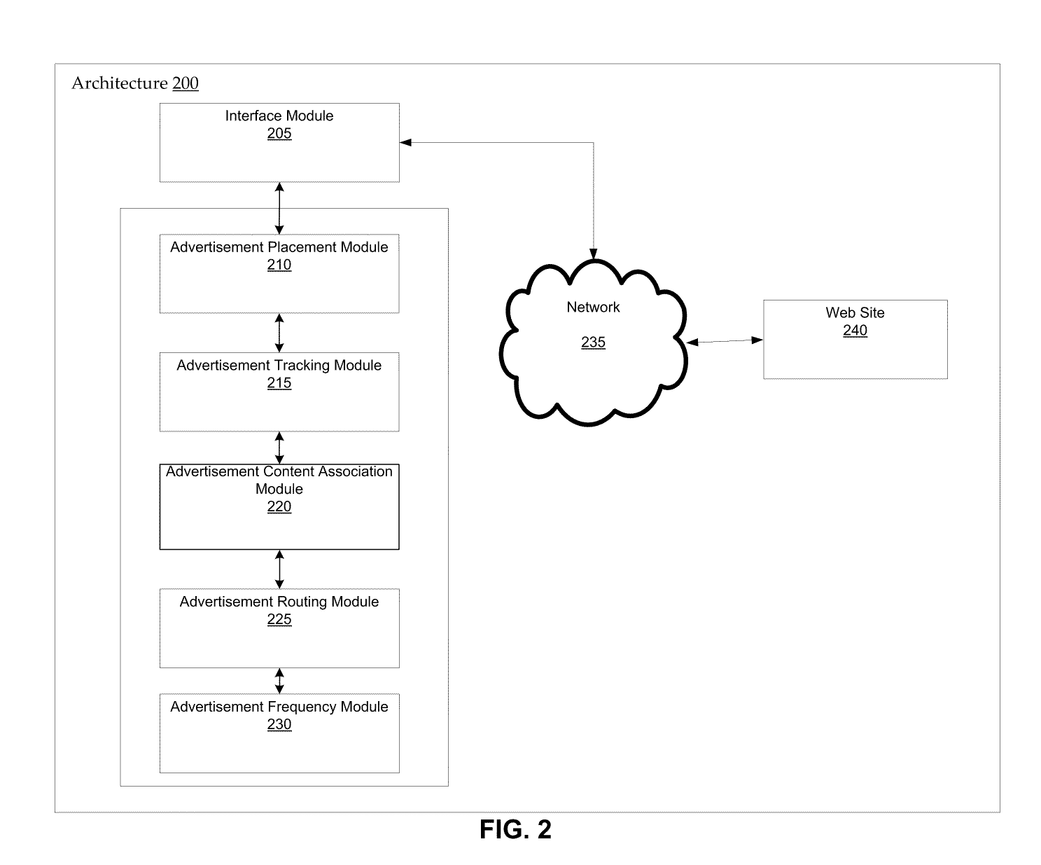

FIG. 2 is a diagram of an exemplary architecture 200 of a system for providing advertisements. The architecture 200 includes an interface module 205, an advertisement placement module 210, an advertisement tracking module 215, an advertisement content association module 220, an advertisement routing module 225, an advertisement frequency module 230, a network 235, and one or more web sites 240. It will be appreciated by one skilled in the art that FIG. 2 (and all of the figures described herein) are exemplary only. The architecture 200 may include any number of modules. Furthermore, any components and/or modules of the architecture 200 can be combined, modified, deleted or added, and the resulting architecture 200 is still within the scope of this invention. The architecture 200 may further comprise one or more servers (not shown), one or more databases (not shown), and one or more clients (not shown). The servers, the databases, and the clients may each comprise one or more computing devices.

A module (or application), as referenced in the present invention, should be generally understood as a collection of routines that perform various system-level functions and may be dynamically loaded and unloaded by hardware and device drivers as required. The modular software components described herein may also be incorporated as part of a larger software platform or integrated as part of an application specific component.

A graphical user interface for real-time visualization of advertisements delivered over a network may include an advertisement placement display, an advertisement tracking display, an advertisement content association display, an advertisement routing display, and an advertisement frequency display. Such a graphical user interface may appear on a web site to a user. The graphical user interface may appear to be a dashboard of information regarding one or more advertisements and one or more stories or news articles.

Referring still to FIG. 2, the interface module 205 provides an interface between the network 235 and one or more advertisement modules, including but not limited to the advertisement placement module 210, the advertisement tracking module 215, the advertisement content association module 220, the advertisement routing module 225, the advertisement frequency module 230, and the advertisement storage module (not shown). The network 235 may be coupled to one or more computing devices (not shown). The network may also be coupled to one or more web sites 240. Through the interface module 205, a computing device may communicate with one or more advertisement modules, such that the advertisements may be displayed, added and/or removed from one or more web sites 240. According to various exemplary embodiments, the interface module 205 may assist in transmitting communications between one or more computing devices and/or one or more web sites, to deliver over a network a visualization in real-time of advertisements pursuant to the methods described herein.

The advertisement placement module 210 is configured to provide an advertisement placement display on a graphical user interface. The advertisement placement display is configured to display an identifier corresponding to a first web site displaying an advertisement. The identifier displayed by the advertisement placement display may be a name of the first web site, a link to the first web site, an address to the first web site, any attribute associated with the first web site, and any combination thereof.

The advertisement tracking module 215 is configured to provide an advertisement tracking display on a graphical user interface. The advertisement tracking display is configured to display quantitative data with respect to the advertisement displayed on the first web site. The quantitative data may include a number of impressions for the advertisement on the first web site, a number of impressions for the advertisement on the first web site per day, a click-through rate for the advertisement on the first web site, a time or position of the advertisement on the first web site, an indication of a change in the time or the position of the advertisement on the first web site, an indication of a change to the first web site, and any combination thereof.

The advertisement content association module 220 is configured to provide an advertisement content association display on a graphical user interface. The advertisement content association display is configured to display a type of content associated with the advertisement displayed on the first web site. The type of content may include any type of information (such as a title of a story). The title of the story may include an identifier of whether the advertisement is associated with the story.

The advertisement routing module 225 is configured to provide an advertisement content association display on a graphical user interface. The advertisement routing display is configured to display routing of the advertisement to a plurality of web sites. The advertising routing display may be further configured to receive an entry designating for placement of the advertisement in association with a second web site from the plurality of web sites. The second site has a correlation to the first web site displaying the advertisement. The advertisement routing display may be further configured to control appearance of the advertisement on the plurality of web sites. In other words, the graphical user interface may provide boxes (such as the box 315). If the box is checked, then the advertisement may be transmitted for display on the one or more web sites associated with the entry associated or adjacent to the checked box. If the box is unchecked, then the advertisement does not appear on the web site associated with the entry adjacent to the checked box.

The advertisement frequency module 230 is configured to provide an advertisement frequency display on a graphical user interface. The advertisement frequency display is configured to display a frequency in which the advertisement is displayed on the first web site. The advertisement frequency display may be further configured to display a web site available for routing the advertisement. In other words, a web site is identified as a potential advertisement placement, which can present an advertisement purchasing opportunity to a user or an advertiser.

It may be appreciated by those skilled in the art that the systems described herein allow for the uploading and/or storing of advertisements with the help of an advertisement storage module (not shown). The advertisement storage module is configured to store advertisements that may be routed to one or more web sites 240. The advertisement storage module may be configured to store advertisements that are transferred or taken off of one or more web sites 240. The advertisement storage module may be coupled to one or more of the modules shown in FIG. 2 (namely, the interface module 205, the advertisement placement module 210, the advertisement tracking module 215, the advertisement content association module 220, the advertisement routing module 225, and the advertisement frequency module 230). The advertisement storage module (not shown) may be coupled to the network 235.

As mentioned earlier, the network 235 may be the Internet, a mobile network, a local area network, or any combination thereof. The network 235 may be a local, proprietary network (e.g., intranet) and/or may be a part of a larger wide-area network. For example, the network 235 may be a local area network (LAN), which may also be communicatively coupled to a wide area network (WAN) such as the Internet. The network 235 allows for communication between the various components of one or more systems described herein.

Although only one web site 240 is shown in FIG. 2, it will be understood by one skilled in the art that one or more web sites 240 may be included in the exemplary architecture 200 of the system. The one or more web sites 240 are web sites that may already display advertisements and/or web sites that are identified as potential advertisement placements (areas where an advertisement may be displayed). The one or more web sites may include a first web site and a second web site. The first web site may display an advertisement. The second web site may be a web site associated with the placement of an advertisement. The second web site may have a correlation to the first web site displaying the advertisement. The second web site may be displayed for routing the advertisement.

FIG. 3 illustrates an exemplary screenshot of a display on a device interacting with some of the various embodiments disclosed herein. The device may be a computing device. The device may include computer readable storage media. FIG. 3 shows a list 305 of news feed entries associated with “ALL NEWS.” In other words, entries that are associated with any type of news are posted in real-time on the list 305. Each entry may include a box that may be checked (such as the checked box 315) or unchecked. Each entry may also include a title of a story and an identifier of the web site that displays the story. Each entry may include an identifier of an advertisement, as described more fully herein.

FIG. 3 also shows an example of a first web site and a second web site. In the entry 310, the first web site is “Inside Bay Area” which is associated with the story “Blu-ray titles to get you started.” The second web site is the web site that includes the exemplary screenshot 300. The second web site is displayed for routing the advertisement. In the case of the entry 310, because the checkbox 315 is checked, the Blu-Ray advertisement is routed for display to the first web site of “InsideBayArea,” where the story “Blu-Ray titles to get you started” already appears. As described more fully in U.S. patent application Ser. No. 12/319,314 filed on Jan. 5, 2009, titled “Systems and Methods for Content Delivery,” the exemplary screenshot 300 of the web site may include stock tickers, such as DISK as shown in the entry 310. Furthermore, the exemplary screenshot 300 shows “ALL NEWS” which can be found below the query box 320. If the user selected or typed in “Information Technology,” the web site would then show all the news feed of the companies associated with the Information Technology sector, but it would not show the news feed of companies that are not associated with the Information Technology. For instance, in “ALL NEWS,” the stock ticker “GM” for “General Motors” is shown for two stories entitled “Sembler might build Falcons stadium in Doraville” and “Elections, economy, storms: Wis. saw it all in '08.” However, if the user selected the “Information Technology” sector, then “Information Technology” would replace the “ALL NEWS” designation, and the stories related to the ticker “GM” would no longer appear since General Motors is not a company associated with the Information Technology sector.

The screenshot 300 also shows how the technology can provide the user with the knowledge of where an advertisement is located on the Internet. If the user is associated with Nokia and wants to determine where all Nokia cellular phone advertisements are located, the user can type in “Nokia cellular phone” in the query box 320 and the technology will deliver in real-time a list (such as the list 305) of news feed entries of all the web pages that have Nokia cellular phone advertisements or are associated with Nokia cellular phones.

According to various exemplary embodiments, the screenshot 300 may provide a list (such as the list 305) that allows for the user to control, select and/or otherwise designate which web sites display an advertisement. If the user is associated with Nokia and wants to have Nokia cellular phone advertisements on web sites that already provide LG cellular phone advertisements, then the user can type in “LG cellular phone” in the query box 320 and the technology will deliver in real-time a list 305 of entries of all the web pages that display LG cellular phone advertisements or are otherwise associated with LG cellular phone advertisements. The user can then easily select and designate which of the identified web sites should also display the Nokia cellular phone advertisement by checking boxes to select those web sites. When the user selects an identified web site by checking a box through user input from a device, the user selection is transmitted through the network (such as the network 235), and the architecture of the system (such as the architecture 200 in FIG. 2) will route the advertisement to the selected web site.

The user can also determine which web sites currently display Nokia cellular phone advertisements by typing in “Nokia cellular phone” in the query box 320. The technology will deliver in real-time a list 305 of entries of all the web pages that display Nokia cellular phone advertisements or are otherwise associated with Nokia cellular phone advertisements. The user can review the list 305 and can deselect or take down from the web site a Nokia cellular phone advertisement the user originally placed on the web site, by unchecking a checked box associated with the web site.

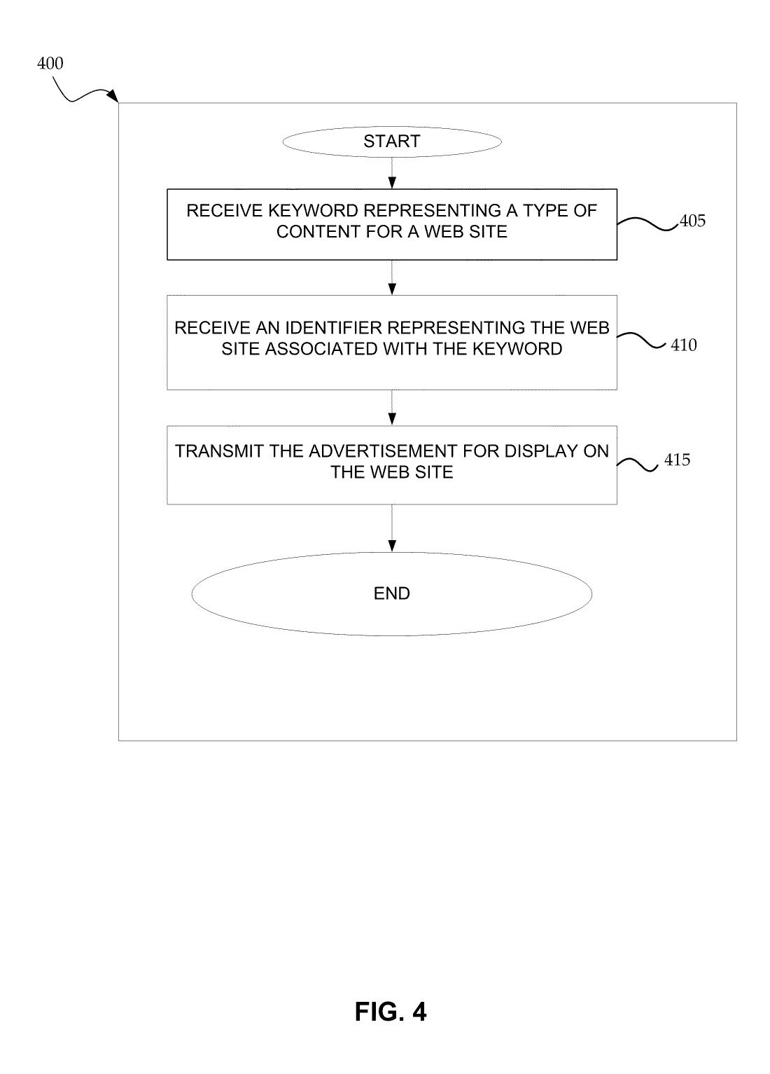

FIG. 4 is a flow chart showing an exemplary method 400 for delivering advertisements. According to some exemplary embodiments, the method is a computer-implemented method for real-time delivery of advertisements over a network. At step 405, a keyword representing a type of content for a web site is received. The keyword may be received by any of the embodiments of the systems and methods described herein. In some embodiments, the keyword is received from a user input on a device. The input may be a query supplied to a query box on a web page (such as the exemplary web page in FIG. 3), as described earlier herein. Besides representing a type of content for a web site, the keyword may also represent a description of an advertisement campaign. An advertisement ad campaign can be searched and/or saved.

At step 410, an identifier representing the web site that is associated with the keyword is received. The identifier representing the web site that is associated with the keyword may include a name of a web site, a link to the web site, an address of the web site, and any combination thereof. In other words, the identifier represents a web site that is associated or may be matched with the keyword that is received. The identifier may identify web sites that currently display advertisements that match the keyword or query. The identifier may help to identify web sites that may be potential advertisement placements. In other words, the identifier may help to identify web sites that match the keywords received, such that the identified web sites should be considered as possible web sites that the user may wish to transmit the advertisement for display.

At step 415, the advertisement is transmitted for display on the web site. According to various embodiments, the advertisement is transmitted for display on the web site utilizing the architecture 200 in FIG. 2. The advertisement may be transmitted for display on a web site (such as one or more web sites 240) via a network (such as the network 235). The advertisement may be provided for visualization in real-time delivery by utilizing one or more of the modules in the architecture 200, namely, the interface module 205, the advertisement placement module 210, the advertisement tracking module 215, the advertisement content association module 220, the advertisement routing module 225, and the advertisement frequency module 230, as described earlier herein.

According to various embodiments, the advertisement may be transmitted for display on a web site after the architecture (such as the architecture 200) of the system receives the keyword(s). The keyword(s) may be provided in the form of a query. The query may be entered in a query box such as the query box 320 in FIG. 3. Once the keyword(s) are received, and an identifier representing a web site associated with keyword is also received, then the web site may be selected for an advertisement placement. Such a selection may be received by the system following a click on the web site, an interaction with a check box (such as checking a check box) or selection box, or any other means of interaction with the identifier that represents the web site. Following the selection, the advertisement may then be transmitted for display for on the web site that is associated with the identifier.

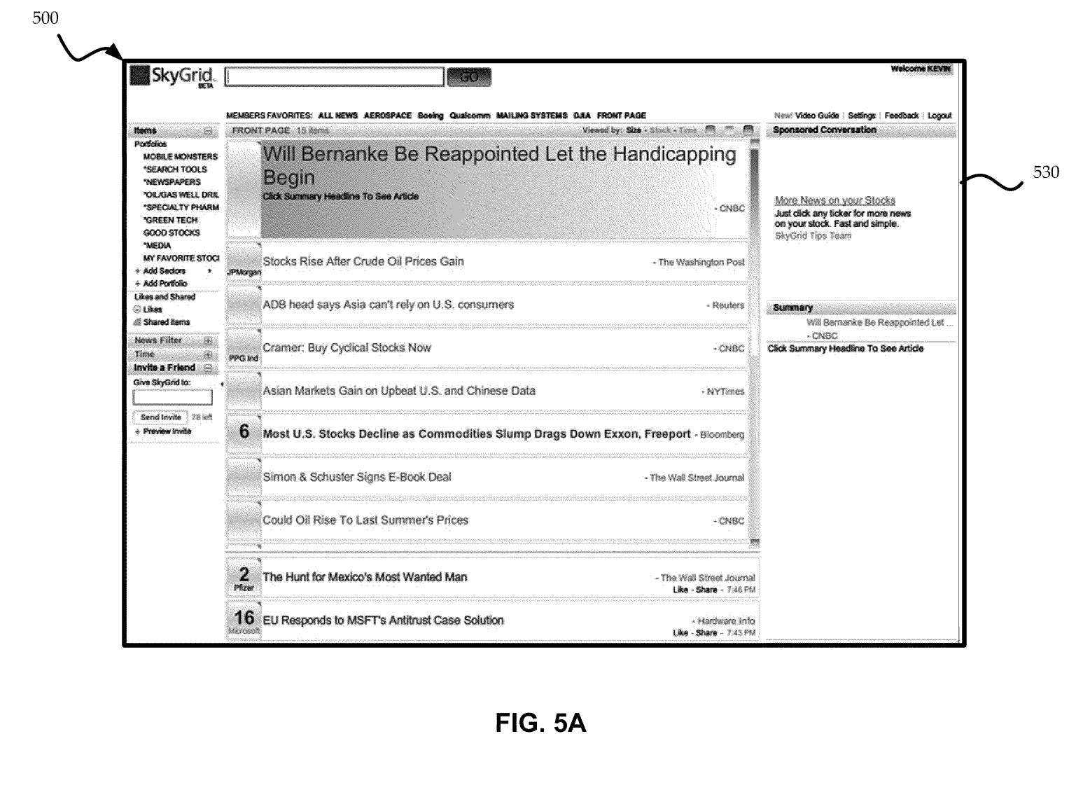

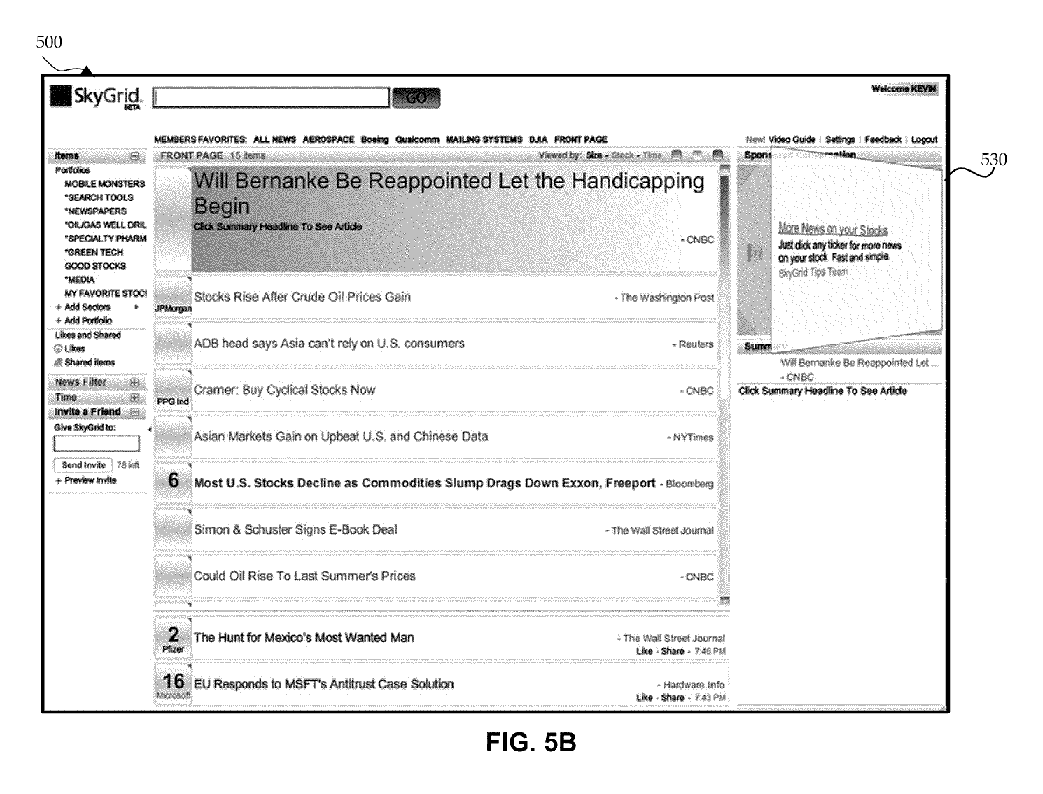

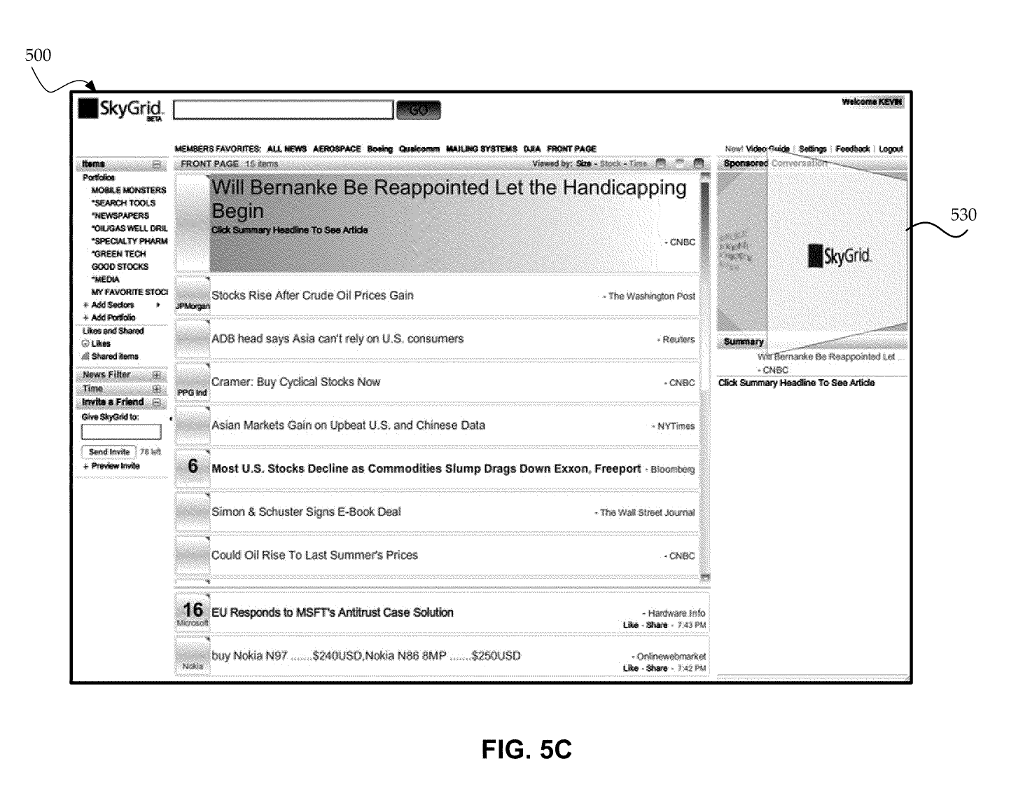

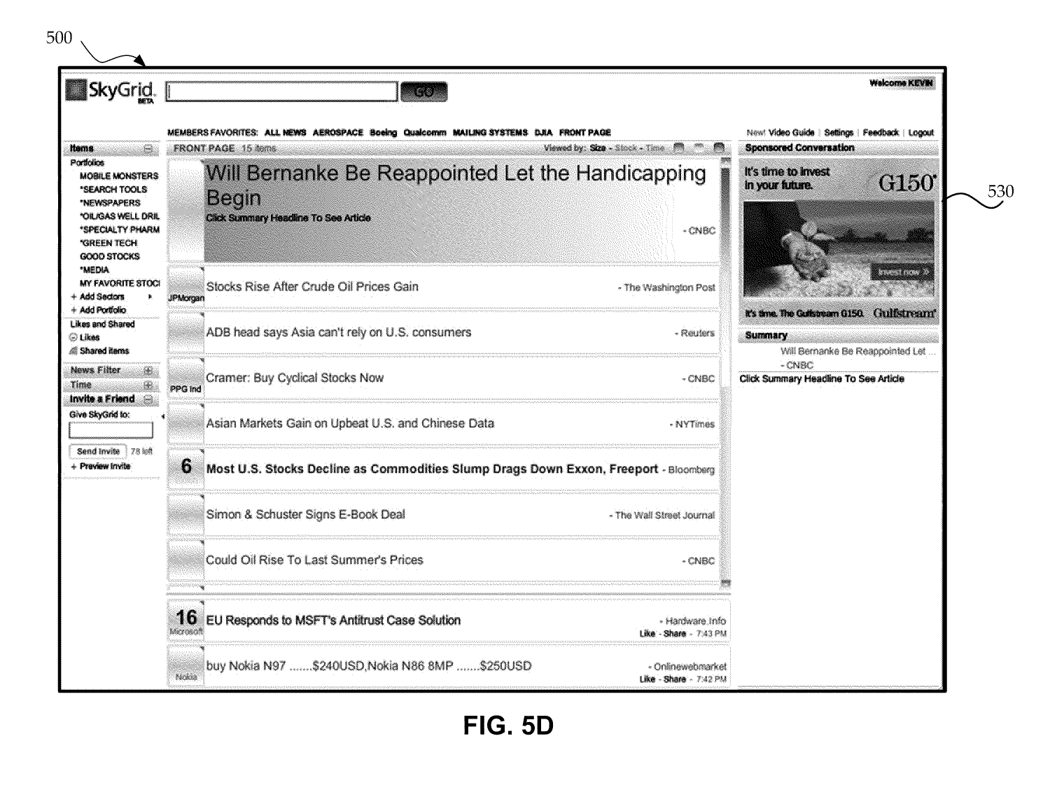

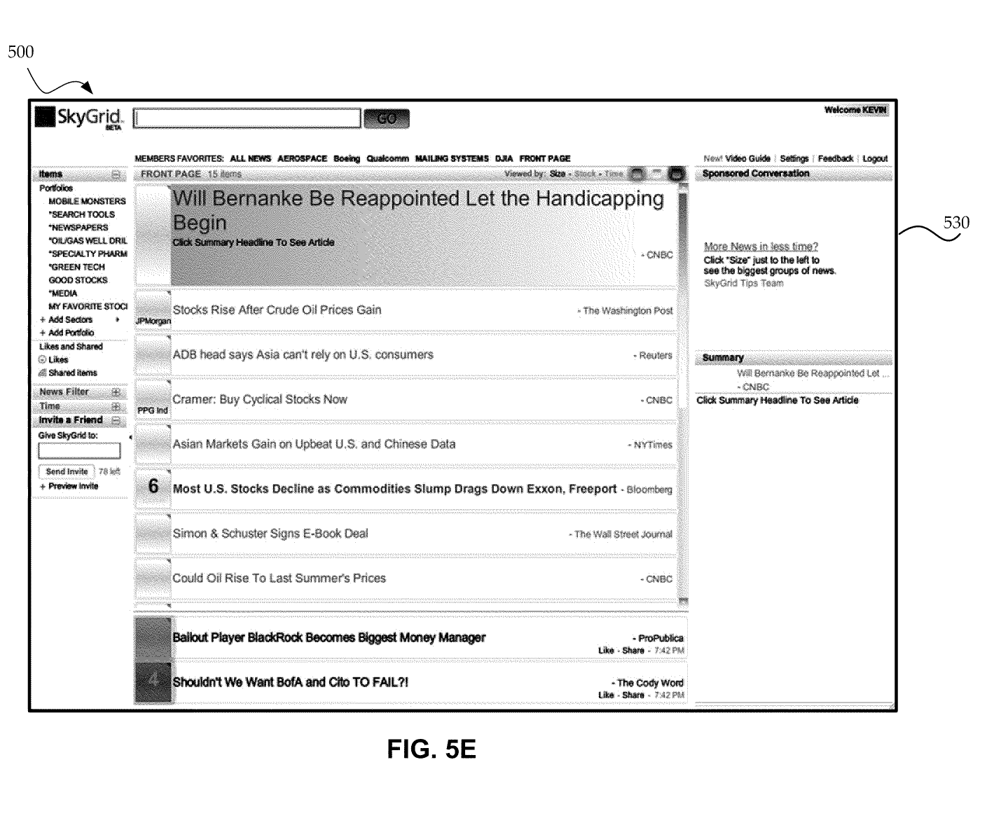

FIGS. 5A, 5B, 5C, 5D, and 5E illustrate exemplary screenshots 500 of a display showing a rotating multiple-sided display object 530 in accordance with some of the various embodiments disclosed herein. Each of the screenshots 500 are similar to the screenshot 300 shown in FIG. 3, except that each of the screenshots 500 show the rotating multiple-sided display object 530. As the rotating multiple-sided display object 530 rotates, a different advertisement is shown on each of the sides of the multiple-sided display object 530. The rotating multiple-sided display object 530 shows a first advertisement in FIG. 5A. While the multiple-sided display object 530 is rotating, as shown in FIG. 5B, the first advertisement and a second advertisement are both shown to the user. As the multiple-sided display object continues to rotate, as shown in FIG. 5C, the second advertisement and a third advertisement are both displayed to the user. Further advertisements are displayed as the rotating multiple-sided display object continues to rotate, as shown in exemplary FIGS. 5D and 5E. One skilled in the art will appreciate that these figures are exemplary only and that any number of sides, advertisements and types of rotation may be presented by the rotating multiple-sided display object 530.

It is noteworthy that any hardware platform suitable for performing the processing described herein is suitable for use with the invention. The terms “computer-readable medium” and “computer-readable media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, punch cards, paper tape, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. A computer-implemented method for real-time delivery of advertisements over a network, the method comprising:
receiving a keyword representing a type of content for a web site;
receiving an identifier representing the web site associated with the keyword; and
transmitting the advertisement for display on the web site.

2. The computer-implemented method of claim 1, wherein the keyword also represents a description of an advertisement campaign.

3. A graphical user interface for real-time visualization of advertisements delivered over a network, the graphical user interface comprising:
an advertisement placement display, the advertisement placement display configured to display an identifier corresponding to a first web site displaying an advertisement;
an advertisement tracking display, the advertisement tracking display configured to display quantitative data with respect to the advertisement displayed on the first web site;
an advertisement content association display, the advertisement content association display configured to display a type of content associated with the advertisement displayed on the first web site;
an advertisement routing display, the advertisement routing display configured to display routing of the advertisement to a plurality of web sites; and
an advertisement frequency display, the advertisement frequency display configured to display a frequency in which the advertisement is displayed on the first web site.

4. The graphical user interface of claim 3, wherein the advertisement routing display is further configured to control appearance of the advertisement on the plurality of web sites.

5. The graphical user interface of claim 3, wherein the identifier displayed by the advertisement placement display is a name of the first web site.

6. The graphical user interface of claim 3, wherein the identifier displayed by the advertisement placement display includes a link to the first web site.

7. The graphical user interface of claim 3, wherein the quantitative data displayed by the advertisement tracking display includes a number of impressions for the advertisement on the first web site.

8. The graphical user interface of claim 3, wherein the quantitative data displayed by the advertisement tracking display includes a number of impressions for the advertisement on the first web site per day.

9. The graphical user interface of claim 3, wherein the quantitative data displayed by the advertisement tracking display includes a click-through rate for the advertisement on the first web site.

10. The graphical user interface of claim 3, wherein the quantitative data displayed by the advertisement tracking display includes a time or a position of the advertisement on the first web site.

11. The graphical user interface of claim 10, wherein the quantitative data displayed by the advertisement tracking display includes an indication of a change in the time or the position of the advertisement on the first web site.

12. The graphical user interface of claim 10, wherein the quantitative data displayed by the advertisement tracking display includes an indication of a change to the first web site.

13. The graphical user interface of claim 3, wherein the type of content displayed by the advertisement content association display includes any type of information.

14. The graphical user interface of claim 3, wherein the type of content displayed by the advertisement content association display includes a title of a story.

15. The graphical user interface of claim 14, wherein the title of the story includes an identifier of whether the advertisement is associated with the story.

16. The graphical user interface of claim 3, wherein the advertising routing display is further configured to receive an entry designating for placement of the advertisement in association with a second web site from the plurality of web sites, the second web site having a correlation to the first web site displaying the advertisement.

17. The graphical user interface of claim 3, wherein the advertisement content association display is further configured to match a received keyword to a web site on the network for displaying an advertisement.

18. The graphical user interface of claim 3, wherein the advertisement content association display is further configured to match a received keyword corresponding to a sector to a web site on the network for displaying an advertisement.

19. The graphical user interface of claim 3, wherein the advertisement content association display is further configured to match a received keyword to a web site on the network displaying an advertisement of a third-party.

20. The graphical user interface of claim 3, wherein the advertisement routing display is further configured to display a web site available for routing the advertisement.

21. The graphical user interface of claim 3, wherein the graphical user interface is configured to display on a display on any type of medium.

22. The graphical user interface of claim 3, wherein the frequency is each time the advertisement appears on one visible side of a rotating multiple-sided display object having three dimensions.

23. The graphical user interface of claim 22, wherein more than one visible side of the rotating multiple-sided display object having three dimensions appears at a particular point in time.

24. The graphical user interface of claim 23, wherein each visible side of the rotating multiple-sided display object has at least one advertisement.

25. The graphical user interface of claim 22, wherein the rotating multiple-sided display object is a prism.

26. The graphical user interface of claim 22, wherein the rotating multiple-sided display object is a cube.

27. The graphical user interface of claim 22, wherein the rotating multiple-sided display object is a polyhedron.

28. The graphical user interface of claim 27, wherein the polyhedron is an octahedron.

29. The graphical user interface of claim 27, wherein the polyhedron is a dodecahedron.

30. The graphical user interface of claim 27, wherein the polyhedron is an icosidodecahedron.

31. The graphical user interface of claim 27, wherein the polyhedron is an elongated pentagonal cupola.

32. The graphical user interface of claim 27, wherein the polyhedron is a pyramid.

33. The graphical user interface of claim 22, wherein the rotating multiple-sided display object is an airplane.

34. The graphical user interface of claim 22, wherein the rotating multiple-sided display object having three dimensions rotates horizontally.

35. The graphical user interface of claim 22, wherein the rotating multiple-sided display object having three dimensions rotates vertically.

36. The graphical user interface of claim 3, wherein the frequency is each time the advertisement appears on at least one side of a multi-dimensional object.

37. The graphical user interface of claim 36, wherein the multi-dimensional object includes the advertisement and at least one other advertisement.

38. A computer-implemented method for real-time display on a graphical user interface of advertisements delivered over a network, the method comprising:
displaying an identifier corresponding to a first web site displaying an advertisement;
displaying quantitative data with respect to the advertisement displayed on the first web site;
displaying a type of content associated with the advertisement on the first web site;
displaying a second web site for routing the advertisement; and
displaying a frequency in which the advertisement is displayed on the first web site.

39. The method of claim 38, wherein the identifier displayed is a name of the first web site.

40. The method of claim 39, wherein the identifier displayed includes a link to the first web site.

41. The method of claim 38, wherein the quantitative data includes a number of impressions for the advertisement on the first web site.

42. The method of claim 38, wherein the quantitative data includes a number of impressions for the advertisement on the first web site for a particular day.

43. A system for real-time display of advertisements delivered over a network, the system comprising:
a processor;
a computer readable storage medium having instructions for execution by the processor which causes the processor to display advertisements delivered over the network;
wherein the processor is coupled to the computer readable storage medium, the processor executing the instructions on the computer readable storage medium to:
transmit to a display an identifier corresponding to a first web site displaying an advertisement;
transmit to the display quantitative data with respect to the advertisement displayed on the first web site;
transmit to the display a type of content associated with the advertisement on the first web site;
transmit to the display a second web site for routing the advertisement; and
transmit to the display a frequency in which the advertisement is displayed on the first web site.

44. The system of claim 43, wherein the display is on any type of medium.

45. The system of claim 43, wherein the quantitative data displayed includes a click-through rate for the advertisement on the first web site.

46. The system of claim 43, wherein the frequency is each time the advertisement appears on one visible side of a rotating multiple-sided display object having three dimensions.

47. The system of claim 46, wherein more than one visible side of the rotating multiple-sided display object having three dimensions appears at a particular point in time.

48. The system of claim 47, wherein each visible side of the rotating multiple-sided display object has at least one advertisement.

49. The system of claim 46, wherein the rotating multiple-sided display object is a prism.

50. The system of claim 46, wherein the rotating multiple-sided display object is a cube.

51. The system of claim 46, wherein the rotating multiple-sided display object is a polyhedron.

52. The system of claim 51, wherein the polyhedron is an octahedron.

53. The system of claim 51, wherein the polyhedron is a dodecahedron.

54. The system of claim 51, wherein the polyhedron is an icosidodecahedron.

55. The system of claim 51, wherein the polyhedron is an elongated pentagonal cupola.

56. The system of claim 51, wherein the polyhedron is a pyramid.

57. The system of claim 46, wherein the rotating multiple-sided display object is an airplane.

58. The system of claim 46, wherein the rotating multiple-sided display object having three dimensions rotates horizontally.

59. The system of claim 46, wherein the rotating multiple-sided display object having three dimensions rotates vertically.

60. The system of claim 43, wherein the frequency is each time the advertisement appears on at least one side of a multi-dimensional object.

61. The system of claim 60, wherein the multi-dimensional object includes the advertisement and at least one other advertisement.

62. The system of claim 43, wherein the processor is configured to execute the instructions on the computer readable storage medium to control appearance of the advertisement on a plurality of web sites.

63. The system of claim 43, wherein the identifier displayed by the display is a name of the first web site.

64. The system of claim 43, wherein the identifier displayed by the display includes a link to the first web site.

65. The system of claim 43, wherein the quantitative data displayed by the display includes a number of impressions for the advertisement on the first web site.

66. The system of claim 43, wherein the quantitative data displayed by the display includes a number of impressions for the advertisement on the first web site per day.

67. The system of claim 43, wherein the quantitative data displayed by the display includes a time or a position of the advertisement on the first web site.

68. The system of claim 67, wherein the quantitative data displayed by the display includes an indication of a change in the time or the position of the advertisement on the first web site.

69. The system of claim 43, wherein the quantitative data displayed by the display includes an indication of a change to the first web site.

70. The system of claim 43, wherein the type of content displayed by the display includes any type of information.

71. The system of claim 43, wherein the type of content displayed by the display includes a title of a story.

72. The system of claim 71, wherein the title of the story includes an identifier of whether the advertisement is associated with the story.

73. The system of claim 43, wherein the processor is further configured to execute the instructions on the computer readable storage medium to receive an entry designating for placement of the advertisement in association with a second web site from a plurality of web sites, the second web site having a correlation to the first web site displaying the advertisement.

74. The system of claim 43, wherein the processor is further configured to execute the instructions on the computer readable storage medium to match a received keyword to a web site on the network for displaying an advertisement.

75. The system of claim 43, wherein the processor is further configured to execute the instructions on the computer readable storage medium to match a received keyword corresponding to a sector to a web site on the network for displaying an advertisement.

76. The system of claim 43, wherein the processor is further configured to execute the instructions on the computer readable storage medium to match a received keyword to a web site on the network displaying an advertisement of a third-party.

77. The system of claim 43, wherein the processor is further configured to execute the instructions on the computer readable storage medium to display a web site available for routing the advertisement.
